(19) United States
(12) Patent Application Publication
(10) Pub. No.: US 2022/0219697 A1
(43) Pub. Date: Jul. 14, 2022

(54) MULTI-OPERATIONAL LAND DRONE

(71) Applicant: Agtonomy, South San Francisco, CA (US)

(72) Inventors: Timothy Bucher, Geyserville, CA (US); Steven Holmes, Redwood City, CA (US); Terrin Eager, Campbell, CA (US)

(21) Appl. No.: 17/647,723

(22) Filed: Jan. 11, 2022

Related U.S. Application Data
(60) Provisional application No. 63/136,197, filed on Jan. 11, 2021.
(60) Provisional application No. 63/210,592, filed on Jun. 15, 2021.
(60) Provisional application No. 63/164,096, filed on Mar. 22, 2021.

(51) Int. Cl. B60W 30/188; B60W 30/182; B60W 40/02; B60W 40/13; G05D 1/00

(52) U.S. Cl. CPC B60W 30/188; B60W 30/182; B60W 40/02; B60W 40/13; G05D 2201/0201; G05D 1/0061; B60W 2040/1307; B60W 2300/15; G05D 1/0016

(57) ABSTRACT

A multi-operational land drone includes a vehicle body, one or more batteries, one or more sensors, and a removeable dashboard. The one or more batteries are disposed on a lower portion of the vehicle body. The one or more sensors are disposed on the vehicle body.

The present application claims priority to U.S. Provisional Patent Application No. 63/136,197, filed on Jan. 11, 2021, U.S. Provisional Patent Application No. 63/164,096, filed on Mar. 22, 2021, and U.S. Provisional Patent Application No. 63/210,592, filed on Jun. 15, 2021. The entire contents of each of which are incorporated by reference in the present disclosure.

### FIELD

The present disclosure is generally directed towards a multi-operational land drone.

### BACKGROUND

Unless otherwise indicated herein, the materials described herein are not prior art to the claims in the present application and are not admitted to be prior art by inclusion in this section.

Farming and agricultural ventures are often associated with labor intensive work and long hours. In some circumstances, long hours may be attributed to the large tracts of land on which the ventures are operated. Oftentimes, many hours are spent on tractors and other agricultural vehicles as part of maintaining the land and crops located thereon.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### BRIEF SUMMARY

In an embodiment, a multi-operational land drone includes a vehicle body, one or more batteries, one or more sensors, and a removeable dashboard. The one or more batteries are disposed on a lower portion of the vehicle body. The one or more sensors are disposed on the vehicle body.

These and other aspects, features and advantages may become more fully apparent from the following brief description of the drawings, the drawings, the detailed description, and appended claims.

### BRIEF DESCRIPTION OF THE DRAWINGS

Example embodiments will be described and explained with additional specificity and detail through the use of the accompanying drawings in which:

FIG. 1 is a block diagram of an example system that includes a multi-operational land drone;

FIG. 2 is a block diagram of an example powertrain control system;

FIG. 3 illustrates a block diagram of an example computing system;

FIG. 4 illustrates a flowchart of an example method of selecting an operating mode of a multi-operational land drone; and

FIG. 5 illustrates a flowchart of an example method of adjusting a powertrain of a multi-operations land drone, all according to one or more embodiments of the present disclosure.

### DESCRIPTION OF EMBODIMENTS

Tractors and other large machinery have long been used to cultivate large tracts of land. In some circumstances, tractors are also used on moderate and small sized farms as they may enable faster and lower effort cultivation regardless of land scale. Operation of the tractors and other machinery in the foregoing circumstances often requires a significant investment of time. Additionally, circumstances may arise where the tractor may be operated in less desirable circumstances, such as operating under extreme winds or temperatures because a harvest window is narrow.

The demand for improving crop yield is a continually pressing matter. While the world population continues to rise, the amount of arable land remains essentially steady, and even declining in some regions. As such, improving the use of arable land becomes even more important to ensure demands for food and other resources are being met.

Operating large machinery, including tractors, in furtherance of developing and farming arable land is often time intensive. Additionally, there may be land in which the soil is suitable for farming and other agricultural uses, but may be difficult to maintain, or impractical and/or unsafe for conventional tractors and machinery.

In some circumstances, large machinery, used in conjunction with agricultural, construction, mining, and other uses, often produces large amounts of pollution that may be harmful to the environment. Additionally, the heavy pollution from the large machinery may also be harmful to plants and crops which are being cultivated with the use of the large machinery.

In some circumstances, example embodiments of the multi-operational land drone may facilitate remote operation in addition to manual operation. For example, the multi-operational land drone may include line-of-sight remote controlled operations, teleoperations using video cameras, and autonomous operations. In addition, the various remote operation modes may enable the use of the multi-operational land drone in circumstances that might otherwise be hazardous or undesirable for the operator. For example, remote operation modes may be used in extreme temperatures or high winds that might otherwise pose risks to the operator.

Some embodiments of the multi-operational land drone may implement an electric power system to aid in reducing the amount of pollution produced by large machinery typically used in agricultural and other settings. For example, the multi-operational land drone may employ an electric motor for propulsion, control of implements and other attachments, and sensor power to the multi-operational land drone.

Some embodiments of the multi-operational land drone may employ one or more batteries as part of the electric power system. The batteries may be located generally near the ground in the multi-operational land drone which may lower the center of gravity. In some embodiments, the lower center of gravity may make the multi-operational land drone more stable in uneven terrain and in high gradient terrain. When used in conjunction with the remote operation modes, the multi-operational land drone may be capable of navigating terrain that may have been unworkable with conventional heavy machinery and similar equipment. The increased maneuverability of the multi-operational land drone may contribute to a greater amount of arable land that was previously unusable which may result in an increased production such as crop yield.

In addition, tractors lacking in traction control may spin wheels or otherwise struggle with traction in certain circumstances. In such circumstances, spinning and/or sliding wheels may cause damage to the soil and terrain, including soil compaction, erosion, and damage to plants. Further, tractors may not be capable of adjusting the amount of power delivered to axles and/or wheels to enable the tractor to be better suited in various operating environments.

In some embodiments of the present disclosure, a tractor (e.g., the multi-operational land drone) may include a variable powertrain that may be capable of adjustment without operator input. For example, the powertrain control system may obtain sensor data that may provide information about an environment in which the tractor is operating. In these or other embodiments, the powertrain control system may adjust the tractor's powertrain based on the obtained sensor data. The adjustment may improve the tractor's performance in the environment. Further, the powertrain control system may use iterations of sensor data to determine different powertrain settings for the tractor's use in various environments and may cause adjustment of the powertrain settings to a particular state prior to entering a particular environment that corresponds to the particular state.

In some embodiments of the present disclosure, the powertrain control system may include traction sensing, traction control, and automatic transitions between powertrain options. In some embodiments, a tractor that automatically switches powertrain modes may reduce the amount of soil and terrain damage by limiting the amount of spinning and/or sliding. Further, automatic transitioning may provide power to the axles and/or wheels in such circumstances that may improve traction and/or stability of the tractor. In some embodiments, a variable powertrain tractor may also reduce energy consumption by limiting the amount of power used by the powertrain when environmental conditions may not warrant additional power.

In the present disclosure, the term “tractor” may refer to an agricultural tractor and/or other power equipment or vehicles that may be used in an agricultural setting. Alternatively or additionally, the term “tractor” may include a power vehicle that may be configured to support and operate an implement, which may be used in the agricultural setting or any other applicable setting. Further, in some embodiments, the tractor may be a multi-operational land drone, such as described in the present disclosure.

Further, while discussed in primarily an agricultural setting, some embodiments of the present disclosure may be used in other settings, such as mining, construction, and/or other locales where large machinery may be beneficial and the like and may be scaled for different environments such as personal home use and industrial, large-scale use. Additionally, the examples of the present disclosure may refer to a tractor including two axles and/or four wheels. However, the number of axles and/or wheels may be greater while still implementing the embodiments of the present disclosure.

Further, it will be understood that although described generally in the singular, the multi-operational land drone may be paired with other multi-operational land drones such as in a fleet, where the multi-operational land drones may be configured to communicate with one another. In addition, the principles of the present disclosure are not limited to multi-operational land drones. It will be understood that, in light of the present disclosure, the multi-operational land drone disclosed herein can be successfully used in connection with other types of automatable land vehicles.

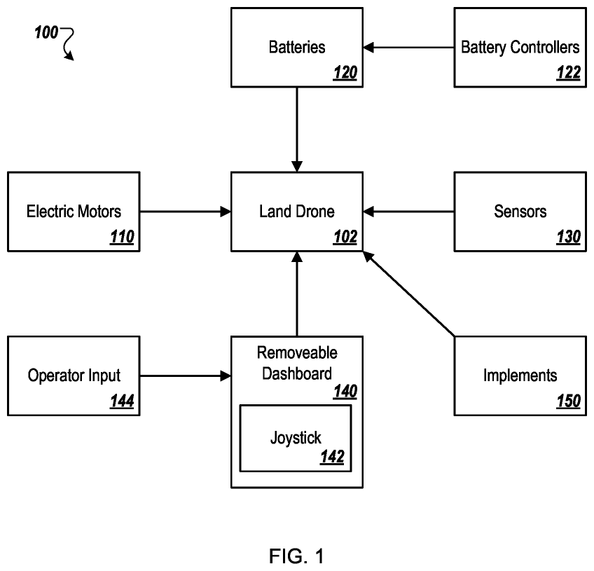

FIG. 1 is a block diagram of an example system 100 that includes a multi-operational land drone 102 (“land drone 102”), in accordance with at least one embodiment described in the present disclosure. The system 100 may include the land drone 102, one or more electric motors 110, one or more batteries 120, sensors 130, a removeable dashboard 140, and implements 150. The batteries 120 may include battery controllers 122. The removeable dashboard 140 may include a joystick 142 and may be configured to receive operator input 144 either directly or via the joystick 142.

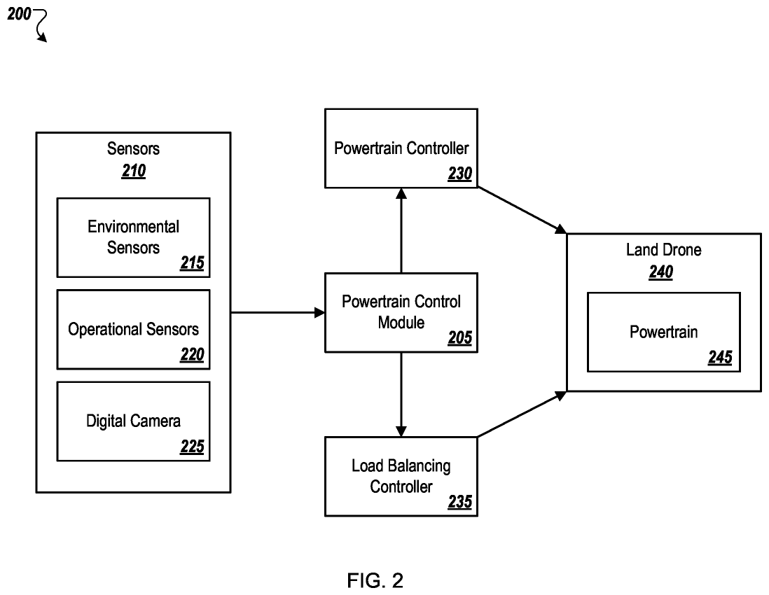

In some embodiments, a primary electric motor may be included in the one or more electric motors 110 (and hereinafter referred to with element 110) and may be used in the propulsion of the land drone 102. In some embodiments, individual wheels of the land drone 102 may include one or more electric motors 110 associated therewith. For example, in instances in which the land drone 102 includes four wheels, an electric motor 110 may be attached and configured to operate each of the four wheels. In some embodiments, the one or more electric motors 110 associated with the wheels may be configured to operate in different capacities, including varying amounts of power delivered to each wheel. For example, in instances in which one or more wheels are slipping, the amount of power delivered by the one or more electric motors 110 associated with the one or more slipping wheels may be adjusted and the amount of power delivered by the one or more electric motors 110 associated with the one or more non-slipping wheels may be adjusted, such that the amount of slipping in the wheels may be reduced. For example, in some embodiments, the power may be adjusted such as described below with respect to FIG. 2

In some embodiments, one or more implements 150 may be attached to and/or used with the land drone 102 and may include an associated electric motor 110. For example, a mower attached to the land drone 102 may include an electric motor 110 configured to power the blades of the mower. Alternatively or additionally, the implements 150 of the land drone 102 may include more than one associated electric motor 110. For example, a sprayer attached to the land drone 102 may include a first electric motor 110 to adjust a nozzle direction and a second electric motor 110 to power the pump used to spray.

In some embodiments, the primary electric motor 110 may provide power to one or more implements connected to the land drone 102. Alternatively or additionally, the primary electric motor 110 may be configured to provide power to other systems included in the land drone 102. For example, the primary electric motor 110 may be configured to provide power to the steering system, the braking system, sensors 130 attached to the land drone 102, auxiliary devices and systems, etc.

In some embodiments, the primary electric motor 110 may receive electrical energy from one or more batteries 120. For example, the one or more batteries 120 may be arranged in series and/or parallel which may produce a voltage and current that may be used by the primary electric motor 110. Alternatively or additionally, the land drone 102 may include a single, high-capacity battery 120. For example, the land drone 102 may include an electric vehicle battery (EVB) 120 that may be designed for high capacity uses, such as powering the primary electric motor 110, the one or more electric motors 110 associated with the one or more wheels, and/or the one or more electric motors 110 associated with the one or more implements 150.

In some embodiments, the one or more batteries 120 may be configured to provide power to all of the one or more electric motors 110. For example, the one or more batteries 120 may jointly provide power to the primary electric motor 110, the one or more electric motors 110 associated with the one or more wheels, and the one or more electric motors 110 associated with the one or more implements 150. Alternatively or additionally, the one or more batteries 120 may be associated with distinct electric motors 110. For example, a first battery of the one or more batteries 120 may be associated with a first electric motor 110 associated with the one or more wheels, a second battery of the one or more batteries 120 may be associated with a second electric motor 110 associated with the one or more wheels, and so forth. Alternatively or additionally, the one or more batteries 120 may be arranged and/or combined such that more than one battery of the one or more batteries 120 may be configured to power a single electric motor 110. For example, a first set of two or more batteries 120 may be combined to provide power to a first electric motor 110 associated with the one or more implements 150, a second set of two or more batteries 120 may be combined to provide power to a second electric motor 110 associated with the one or more wheels, and so forth.

In some embodiments, the one or more batteries 120 may include rechargeable materials which may include lithium-ion batteries, lithium polymer batteries, sodium nickel chloride batteries, or other suitable rechargeable battery types for electric vehicles. Alternatively or additionally, the primary electric motor 110 may receive electrical energy from a photovoltaic system configured to convert solar energy into electrical energy, or a combination of the two sources.

In some embodiments, the one or more batteries 120 may include one or more battery controllers 122. For example, the number of battery controllers 122 may be equal to the number of batteries 120, such that each battery controller 122 is associated with a battery 120. Alternatively or additionally, one battery controller 122 may be associated with the one or more batteries 120. In some embodiments, the one or more battery controllers 122 may be configured to monitor and/or control the charge and discharge of the one or more batteries 120. For example, the one or more battery controllers 122 may limit the rate that the one or more batteries 120 charge and/or discharge which may improve the longevity and/or health of the one or more batteries 120. In some embodiments, the one or more battery controllers 122 may monitor the status of the one or more batteries 120. For example, the one or more battery controllers 122 may monitor a current charge capacity, a maximum charge capacity, a charging temperature, an operating temperature, and/or other battery status indicators.

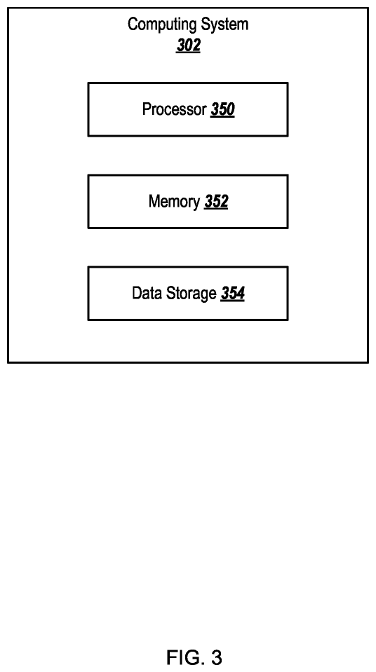

In some embodiments, the one or more battery controllers 122 may be configured to disable the corresponding batteries 120. For example, in instances in which the one or more batteries 120 operating temperature exceeds a threshold, the one or more battery controllers 122 may disable the one or more batteries 120 which may reduce the chance of damage to the one or more batteries 120 and/or nearby people including the operator. In some embodiments, the operation of the battery controllers 122 may be performed by a computing system, such as the computing system 302 of FIG. 3.

In some embodiments, the one or more batteries 120 may be charged by connecting to one or more of an electrical outlet, a photovoltaic system, regenerative braking, and/or other mechanisms. In these and other embodiments, the one or more batteries 120 may receive electrical energy from one source or any combination of sources. In some embodiments, the one or more batteries 120 may be configured to quickly recharge. For example, when connected to an outlet, the one or more batteries 120 may charge approximately 80 percent of its total capacity in approximately 30 minutes. In some embodiments, the one or more batteries 120 may be removeable and/or replaceable in instances in which the one or more batteries 120 becomes damaged or defective.

In some embodiments, the one or more batteries 120 may contribute to the stability of the land drone 102. For example, the one or more batteries 120 may be attached to the bottom of the chassis of the land drone 102. In instances in which the one or more batteries 120 are attached to a lower portion of the land drone 102, the weight of the one or more batteries 120 may contribute to a low center of gravity for the land drone 102. In some embodiments, the land drone 102 may include a small ground clearance that may contribute to a low center of gravity. In some embodiments, the land drone 102 may include a wide track and/or a long wheelbase that may contribute to the stability to the land drone 102. In some embodiments, the land drone 102 may support more than two wheels per axle which may contribute to the stability thereof. In these and other embodiments, various combinations of battery placement, ground clearance, track width, wheelbase length, and number of wheels may be employed to modify the center of gravity and/or the stability of the land drone 102, which may enable the land drone 102 to traverse land that may have been previously inaccessible.

In some embodiments, the land drone 102 may include one or more sensors 130 configured to provide details regarding various aspects of the land drone 102 systems and the environment in which it is located, which may aid navigating the land drone 102. For example, the land drone 102 may incorporate such sensors 130 including, but not limited to digital cameras, lidar, radar, accelerometers, gyroscopes, GPS, and/or other sensors and systems. Further examples of the sensors 130 may include the sensors described below with respect to FIG. 2.

In some embodiments, the land drone 102 may include multiple modes of operation. The modes of operation may include manual operation mode and remote operation modes. In some embodiments, manual operation mode may be configured to receive all control and input from the operator 144 presently operating the land drone 102.

In some embodiments, the land drone 102 may detect, such as by the one or more sensors 130 included therein, that a current operating environment may be hazardous to the operator. In instances where a hazardous operating environment is detected, the land drone 102 may provide an indication to the operator that the operating environment is hazardous for operation, such as by the removeable dashboard 140 as described below. Alternatively or additionally, the land drone 102 may cease to operate if an operator is detected on the land drone 102 in a hazardous environment. A hazardous environment may include steep slopes that may be likely to cause instability, low hanging tree branches or other obstacles, extreme hot or cold temperatures, and/or other similar conditions.

In some embodiments, remote operation modes may enable the operator to be removed from the proximity of the land drone 102, including physically contact with the land drone 102 such as during operation thereof. In some embodiments, the remote operation modes may include line-of-sight remote control mode, teleoperation control mode, and autonomous navigation mode.

In some embodiments, line-of-sight remote control mode may include control of the land drone 102 while still within sight of the operator. For example, in line-of-sight remote control mode, the operator may determine the movements of the land drone 102 based on the operator's perception of the environment around the land drone 102. In line-of-sight remote control mode, the land drone 102 may operate analogously to an RC car with the operator using a controller.

In some embodiments, teleoperation control mode may include remote control by the operator but may also include operations without a line-of-sight to the drone 102. For example, the land drone 102 may include sensors 130 such as digital cameras which may deliver a video feed to a controller the operator is using. In such circumstances, the operator may operate the land drone 102 in view of the perceived surroundings as viewed through the video feed. In teleoperation control mode, the operator may be capable of operating the land drone 102 at a greater range than line-of-sight remote control mode as the land drone 102 may operate without a line-of-sight.

In some embodiments, autonomous navigation mode may include hands-off operation of the line-of-sight remote control mode. For example, in autonomous navigation mode, the land drone 102 may be enabled to move and operate without input from the operator 144.

In some embodiments, the land drone 102 may seamlessly switch between the remote operation modes in addition to switching from manual operation mode to any of the remote operation modes. In these and other embodiments, the mode of operation may be determined by the operator. Alternatively or additionally, the land drone 102 may be configured to automatically switch between modes. For example, the land drone 102 may switch from line-of-sight remote control mode to teleoperation control mode in instances when the land drone 102 determines it is too far from the operator.

In some embodiments, the remote operation modes of the land drone 102 may be controlled by a removable dashboard 140. In some embodiments, the operation of the removeable dashboard 140 may be performed by a computing system, such as the computing system 302 of FIG. 3. In some embodiments, the removable dashboard 140 may be an electronic device. The removeable dashboard 140 may be a custom electronic device configured to operate with the land drone 102. Alternatively or additionally, the removeable dashboard 140 may include a mobile device such as a mobile phone or tablet, which may be configured to interface with the land drone 102. In some embodiments, the removeable dashboard 140 may include multiple electronic devices, each configured to interact with each other and the land drone 102, any of which may be configured to monitor and control the land drone 102. Alternatively or additionally, one electronic device may be designated as a primary device of the removeable dashboard 140 and additional devices may be configured to communicate with the primary device to monitor and control the land drone 102.

The removable dashboard 140 may be configured to dock with the land drone 102. In the docked configuration, the removable dashboard 140 may be configured to provide the operator with details related to various statuses of the land drone 102. Alternatively or additionally, the removeable dashboard 140 may be configured to provide the operator with the various statuses in an undocked and/or remote mode.

In some embodiments, the removable dashboard 140 may include a GUI for displaying the various statuses and modes of operation. For example, the removable dashboard 140 may provide a display of various statuses and modes of operation of the land drone 102 including, but not limited to, current speed, current engine RPM, power takeoff operation, power takeoff RPM, battery life (as a percentage of total battery life), estimated remaining operational time, performance mode, steering mode, crop view mode, hydraulics mode, wheel drive mode, and/or a differential mode.

In some embodiments, the removeable dashboard 140 may be configured to receive input from the operator 144. The removeable dashboard 140 may be configured to receive input in a docked configuration or an undocked configuration. In some embodiments, input from the operator 144 may be in conjunction with setting limitations on the operation and performance of the land drone 102. In some embodiments, the removeable dashboard 140 may be configured to receive operational constraints. For example, the input from the operator 144 may set a maximum braking amount, a maximum acceleration amount, a maximum operating RPM, a maximum speed, a control sensitivity variable (used in conjunction with remote operations as described below), a steering sensitivity variable, and/or a float sensitivity variable. In some embodiments, in instances in which input from the operator 144 is not provided, a default variable may be used until input from the operator 144 is submitted to change the default value.

In some embodiments, the removeable dashboard 140 may be configured to communicate with other electronic devices. In instances in which the removeable dashboard 140 is communicating with other electronic devices, the communications may occur via cellular communication, electromagnetic radiation including radio waves, Wi-Fi, WiMAX, Bluetooth®, and/or similar wireless communication channels. In some embodiments, the other connected electronic devices may be configured to send instructions and/or controls to the removeable dashboard 140, which may control the land drone 102. Alternatively or additionally, the other connected electronic devices may be restricted from communicating with the removeable dashboard 140 unless they are a recognized device and/or have been granted permission to access the land drone 102 via the removeable dashboard 140.

In some embodiments, the removeable dashboard 140 may be configured to receive input from the operator 144 to transition the land drone 102 from manual operations to remote operation modes. In instances in which the operator selects line-of-sight remote control mode from the status page of the GUI, the removeable dashboard 140 may transition from the GUI display to a controller display, and the removeable dashboard may become the controller for the land drone 102 in line-of-sight remote control mode. Alternatively or additionally, the operator may select line-of-sight remote control mode while in teleoperation control mode or in autonomous navigation mode which may transition the removeable dashboard from either of the teleoperation control display or the autonomous navigation display to the line-of-sight remote control display.

In some embodiments, in the line-of-sight remote control mode, the removeable dashboard 140 may provide one or more digital joysticks 142 configured to receive input from the operator 144 to control the land drone 102. The one or more digital joysticks 142 may be patterned after physical joysticks that may be located on and used in conjunction with the land drone 102. In some embodiments, the removeable dashboard 140 may include a digital movement control joystick 142 with at least four directions, that when pressed, move the land drone 102 in the direction the digital movement control joystick 142 is pressed. For example, when the operator presses forward on the digital movement control joystick 142 displayed on the removeable dashboard 140, the land drone 102 may travel in a forward direction until the digital movement control joystick 142 is no longer pressed.

In some embodiments, the removeable dashboard 140 in line-of-sight remote control mode may include a second joystick 142 configured to operate an implement 150 attached to the land drone 102. Controls for the second joystick 142 may be analogous to the movement control joystick 142. Alternatively or additionally, the second joystick 142 may include movements such as raise and/or lower in order to be better suited to operate and control an attached implement 150.

In some embodiments, the removeable dashboard 140 in line-of-sight remote control mode may continue to display various statuses of the land drone 102 in addition to the one or more digital joysticks 142.

In some embodiments, the removeable dashboard 140 may be configured to detect or calculate a distance to drone value that may include an approximate distance between the removeable dashboard 140 and the land drone 102. In some embodiments, the distance to drone value may be used to determine when the land drone 102 is too far from the operator to continue in line-of-sight remote control mode. For example, the land drone 102 may be configured to stop operation when the distance to drone value becomes greater than a threshold.

In some embodiments, the threshold may be a default threshold which may include a predetermined safe operational distance. For example, a default threshold may include up to 100 meters between the land drone 102 and the removeable dashboard 140. In some embodiments, the default threshold may vary with the time of day and/or the amount of light available. For example, in full daylight, the threshold may be approximately 100 meters. In lowlight settings, the threshold may be reduced, such as approximately 15 meters. In some embodiments, the threshold may be a continuum between full light settings and lowlight settings. In some embodiments, the threshold may vary with operator. For example, an operator may have a profile (e.g., as described below) that may assign the threshold to the operator's account. For example, a new operator or an operator with diminished eyesight may have a smaller threshold than an experienced user or a user with 10/20 vision.

In some embodiments, the land drone 102 may cease operations when the distance to drone value exceeds the threshold. Alternatively or additionally, the land drone 102 may transition from line-of-sight remote control mode to another autonomous mode, such as teleoperation control mode or autonomous navigation mode.

In instances in which the operator selects teleoperation control mode from the status page of the GUI, or the land drone 102 transitions to teleoperation control mode, the removeable dashboard 140 may transition from the GUI display to a controller display, and the removeable dashboard may become the controller for the land drone 102 in teleoperation control mode. Alternatively or additionally, the operator may select teleoperation control mode while in line-of-sight remote control mode or in autonomous navigation mode which may transition the removeable dashboard from either of the line-of-sight remote control display or the autonomous navigation display to the teleoperation control display.

In some embodiments, the teleoperation control mode may include one or more digital joysticks 142, which may be analogous to the digital joysticks 142 described in relation to the line-of-sight remote control mode. Alternatively or additionally, the one or more digital joysticks 142 may operate to control the land drone 102 analogously to the movement and control described in relation to the line-of-sight remote control mode.

In some embodiments, the removeable dashboard 140 in teleoperation control mode may display one or more video feeds. The one or more video feeds may be provided from one or more sensors 130 such as one or more digital cameras attached to the land drone 102. In some embodiments, the video feeds may provide a visual indication of the surroundings of the land drone 102. Alternatively or additionally, the digital cameras attached to the land drone 102 may be configured to be controlled via the removeable dashboard in teleoperation control mode. For example, the operator may pan, tilt, and/or zoom the digital cameras using an interface on the teleoperation control display on the removeable dashboard 140.

In some embodiments, the removeable dashboard 140 in teleoperation control mode may continue to display various statuses of the land drone 102 in addition to the one or more digital joysticks 142. Alternatively or additionally, the various statuses may be displayed in a reduced and/or compact size to accommodate the one or more video feeds displayed as part of the teleoperation control mode.

In instances in which the operator selects autonomous navigation mode from the status page of the GUI, or the land drone 102 transitions to autonomous navigation mode, the removeable dashboard 140 may transition from the GUI display to an autonomous navigation display, where the display may provide the various statuses of the land drone 102. Alternatively or additionally, the operator may select autonomous navigation mode while in line-of-sight remote control mode or in teleoperation control mode which may transition the removeable dashboard 140 from either of the line-of-sight remote control display or the teleoperation control display to the autonomous navigation display.

In some embodiments, the removeable dashboard 140 in autonomous navigation mode may provide the various statuses of the land drone 102, as described above. Alternatively or additionally, the removeable dashboard 140 in autonomous navigation mode may display one or more video feeds, analogous to the video feeds of the teleoperation control mode. In instances in which one or more video feeds are displayed in association with autonomous navigation mode, the digital cameras attached to the land drone 102 may be configured to be controlled via the removeable dashboard 140.

In some embodiments, the display of the removeable dashboard 140 in autonomous navigation mode may be altered and/or arranged according to input from the operator 144. For example, the operator may desire to see one video feed, the current speed, and the battery life of the land drone 102 and the operator may arrange the three displays in any configuration. Alternatively or additionally, the operator may add and/or remove additional displays as desired.

In some embodiments, the removeable dashboard 140 may request a user sign in on the removeable dashboard 140 prior to becoming the operator of the land drone 102. In these and other embodiments, some or all of the features provided by the removeable dashboard 140 may be restricted to authorized profiles and/or accounts. For example, a new operator's account may be limited to manual operation mode, and none of the remote operation modes. In the prior example, the new operator may acquire additional training, after which, the profile may be granted additional permissions, such as the option to operate the land drone 102 in line-of-sight remote control mode. In general, various modes of operation may be enabled or restricted with an individual profile.

In some embodiments, various settings and display arrangements of the removeable dashboard 140 may be saved and/or stored with the active profile during which changes were made. In these and other embodiments, new profiles may include a default layout, subject to change by the new user, which may include determined and location of displayed statuses, video feeds (as applicable), default operational constraints, etc.

In some circumstances, some embodiments of the present disclosure may enable the land drone 102 to operate similarly, and in analogous terrains and conditions as conventional machinery. For example, manual operation mode may include an operator riding on the land drone 102 while providing direct input thereto.

In some circumstances, example embodiments of the present disclosure may enable the land drone 102 to be operated in conditions and terrains that may have been previously unworkable. For example, the grade of a hill may be inclined at such an amount that driving machinery thereon would be unsafe or impossible. In such instances, the operator of the land drone 102 may dismount, take the removeable dashboard 140, switch the mode to line-of-sight remote control mode, and proceed to continue operating the land drone 102 on the steep terrain. As discussed above, the land drone 102 may be capable of operation on steep terrain due to a low center of gravity, also discussed above, and use of the removeable dashboard 140 in line-of-sight remote control mode may also enable the operator to maintain safety while continuing operations.

In another example, extreme temperatures, or high winds may make it difficult for conventional machinery and/or operators to complete certain tasks. In such instances, the operator of the land drone 102 may take the removeable dashboard 140 to a safer location and enable teleoperations control mode. As discussed, teleoperations control mode may enable the operator to be remote from the land drone 102 while still performing the tasks and/or operations as though present with the land drone 102. In such circumstances, the operator may be in a safer position and still maintain direct control over the land drone 102, while maintaining an awareness of the surroundings of the land drone 102.

In the preceding circumstances, the operator of the land drone 102 may also choose to enable autonomous navigation mode which may be capable of operations in those and other circumstances. While in autonomous navigation mode, the operator may be allowed to remain remote from the land drone 102 while the operations are performed in potentially hazardous scenarios.

FIG. 2 is a block diagram of an example powertrain control system 200 that may be associated with a tractor or other similar vehicle, in accordance with at least one embodiment described in the present disclosure. The powertrain control system 200 may include a powertrain control module 205, one or more sensors 210, a powertrain controller 230, load balancing system 235, and a land drone 240. The land drone 102 of FIG. 1 is an example of the land drone 240. Additionally, although FIG. 2 is described in the context of a land drone, the concepts may apply to a tractor or any other applicable vehicle or piece of machinery.

The land drone 240 may include a powertrain 245. The powertrain 245 may include any suitable system, device, or component that may operate as a powertrain of the land drone 240 by converting power into movement by the land drone 240. For example, the powertrain 245 may include one or more of an engine, a transmission, an electric motor, a driveshaft, differentials, axles, etc.

In some embodiments, the one or more sensors 210 of the powertrain control system 100 may include environmental sensors 215. The environmental sensors 215 may be configured to detect an operating environment of the land drone 240. For example, the environmental sensors 215 may be configured to detect current terrain conditions including a slope amount such as from hills or depressions, driving surface conditions including accumulated precipitation and soil conditions such as an amount of soil compaction, a moisture level, and/or other soil factors. Alternatively or additionally, the environmental sensors 215 may be configured to detect upcoming terrain conditions including a slope amount such as from hills or depressions, driving surface conditions including accumulated precipitation and soil conditions such as an amount of soil compaction, a moisture level, and/or other soil factors. In these and other embodiments, the powertrain control module 205 may be configured to obtain data produced by the environmental sensors 215.

In these or other embodiments, the one or more sensors 210 may include operational sensors 220. The operational sensors 220 may be configured to detect the handling and response of the land drone 240 to the operating environment. For example, the operational sensors 220 may be configured to detect slipping in the wheels of the tractor, the weight distribution of the land drone 240 including the amount of force exerted through each axle end and/or wheel, load distribution and usage characteristics associated with an attached implement, and/or other tractor conditions. In some embodiments, the operational sensors 220 may be configured to determine one or more characteristics associated with the attached implement, which characteristics may contribute to the dynamics, stability, and/or operation of the powertrain control system 200. In these and other embodiments, the powertrain control module 205 may be configured to obtain data produced by the operational sensors 220. In some embodiments, the environmental sensors 215 used in detecting the operating environment and the one or more operational sensors 220 used in detecting the handling and response of the land drone 240 to the operating environment may include the same or substantially the same sensors.

In some embodiments, the one or more operational sensors 220 may include cameras (which may include or be in addition to a digital camera 225), lidar, radar, accelerometers, gyroscopes, GPS, penetrometers, wheel speed sensors, force sensors, and/or other sensors configured to detect an operating environment and/or a tractor's response to the operating environment. For example, the operational sensors 220 of the one or more sensors 210 may detect the current grade, the future grade, positional data, soil consistency and/or hardness, wheel speed, tractor weight distribution, and/or other operating environment variables.

The powertrain control module 205 may include code and routines configured to enable a computing system to perform one or more operations. Additionally or alternatively, the powertrain control module 205 may be implemented using hardware including a processor, a microprocessor (e.g., to perform or control performance of one or more operations), a field-programmable gate array (FPGA), or an application-specific integrated circuit (ASIC). In some other instances, the powertrain control module 205 may be implemented using a combination of hardware and software. In the present disclosure, operations described as being performed by the powertrain control module 205 may include operations that the powertrain control module 205 may direct a corresponding system to perform. Further, although described separately in the present disclosure to ease explanation of different operations performed and roles, in some embodiments, one or more portions of the powertrain control module 205 may be combined or part of the same module.

In some embodiments, a land drone 240 with the powertrain control system 200 may include two-wheel drive (e.g., 2WD) and/or four-wheel drive (e.g., 4WD) powertrains 245 that may be variable based on a command received from the powertrain controller 230, which may be configured to receive commands from the powertrain control module 205. Alternatively or additionally, the powertrain 245 may include one or more motorized implements which may increase the number of drive wheels to a number greater than four. In these and other embodiments, the powertrain control module 205 may be configured to control the torque delivered to individual wheels (including those of the motorized implements) through the powertrain controller 230. For example, in response to detected environmental conditions (e.g., from environmental data from the environmental sensors 215) and current operating conditions (e.g., from operational data from the operation sensors 220), the powertrain control module 205 may adjust the performance of each wheel as needed to improve traction, reduce terrain damage, and/or otherwise improve the performance and handling of the land drone 240.

In some embodiments, the powertrain controller 230 may be configured to interface with the powertrain control module 205 and/or the land drone 240, including the powertrain 245 thereof. For example, the powertrain controller 230 may be configured to receive input from the powertrain control module 205 that may be used by the powertrain controller 230 to direct operations and/or transitions of the powertrain 245. Additionally or alternatively, the powertrain control module 205 may be integrated with the powertrain controller 230.

In some embodiments, the powertrain controller 230 may include one or more motors, actuators, and/or other mechanical devices configured to operate the powertrain 245. For example, in instances in which the powertrain 245 is in 2WD and the powertrain control module 205 determines the powertrain should transition to 4WD, the powertrain controller 230 may cause an actuator of the land drone 240 to transition the powertrain 245 from 2WD to 4WD.

In some embodiments, the powertrain control module 205 may be configured to receive operator input to direct the powertrain controller 230 to switch the powertrain 245 from 2WD to 4WD and vice versa (e.g., transitioning between powertrains). Alternatively or additionally, the powertrain control module 205 may respond to current operating conditions based on input from the one or more sensors 210 (e.g., data from the environmental sensors 215, data from the operational sensors 220, and/or images from the digital camera 225) to command the powertrain controller 230 to automatically transition the powertrain 245 to a different powertrain. For example, in instances in which the powertrain control module 205 receives data from the one or more sensors 210 that indicate a wet and/or slippery driving surface, the powertrain control module 205 may provide an output to the powertrain controller 230 to automatically cause powertrain 245 to transition from 2WD to 4WD to improve traction and/or control of the land drone 240. Alternatively or additionally, the powertrain control module 205 may predictively command the powertrain controller 230 to transition the powertrain 245 between the various powertrains based on input from the one or more sensors 210 and/or based on learned scenarios which may have previously caused the powertrain control module 205 to transition the powertrain 245 between powertrains. For example, in instances in which the one or more sensors 210, such as the digital camera 225, lidar, or radar, detect an upcoming grade, the powertrain control module 205 may automatically direct the powertrain controller 230 to transition the powertrain 245 from 2WD to 4WD in anticipation of decreased traction.

In some embodiments, the powertrain control module 205 may be configured to receive input from an attached implement. In some embodiments, the implement inputs may be determined using the operational sensors 220. For example, the operational sensors 220 may determine an amount of resistance contributed by the attached implement to the land drone 240, the load contributed by the attached implement to the land drone 240, the distribution of the load relative to the land drone 240, etc. In some embodiments, the implement inputs may be dynamic and vary in time. For example, a harrow used in a first field that includes loamy soil may contribute a resistance to the land drone 240 that may differ from a harrow used in a second field that includes clay-like soil. In another example, an attached and retracted mower may include a load and load distribution profile that may differ from an attached and extended mower. In some embodiments, the implement inputs may be static and/or associated with a particular implement. For example, a first mower may be larger than a second mower and the first mower may include a different load and load distribution profile than the second mower. In these and other embodiments, the powertrain control module 205 may adjust the output to the powertrain controller 230 to control the powertrain 245 in response to the implement inputs which may improve the traction and/or performance of the land drone 240.

In some embodiments, the powertrain 245 may include two or more independently controlled axles. In some embodiments, a motor may be configured to provide power to one or more of the axles. For example, the land drone 240 may be configured to deliver power to either a front axle or a rear axle in 2WD mode, or to both the front axle and the rear axle in 4WD mode. Alternatively or additionally, powertrain 240 of the land drone 240 may include motors disposed at each axle end such that each wheel may be individually controlled. For example, in instances in which the powertrain control module 205 detects the left, rear wheel slipping relative to the other wheels (e.g., based on data received from one or more of the sensors 210), the powertrain control module 205 may adjust the power delivered to the left, rear wheel which may limit wheel slipping and maintain substantially similar motion to the other wheels. In some embodiments, the powertrain control module 205 may determine that the land drone 240 may benefit from different amounts of power being delivered to each wheel of the land drone 240, such that the variable power delivered to each wheel may result in substantially similar motion in each of the four wheels of the land drone 240.

In some embodiments, the powertrain control module 205 may be configured to store environmental and/or operational conditions (e.g., as detected by one or more of the sensors 210) to predict future operational responses for the powertrain control system 200, which may include the powertrain control module 205 commanding the powertrain controller 230 to transition the powertrain 245 of the land drone 240.

For example, the powertrain control module 205 may be configured to store detected grade and surface conditions. Alternatively or additionally, the powertrain control module 205 may be configured to associate the detected grade and surface conditions with positional data. In some embodiments, the powertrain control module 205 may be configured to predict future operational responses of the powertrain system 205, based on the stored detected grade and surface conditions and the positional data associated therewith

For example, in instances in which the powertrain control module 205 determines the grade may be steep at a first position (e.g., based on the stored grade and surface conditions associated with the first position), the powertrain control module 205 may direct the powertrain controller 230 to transition the powertrain 245 from 2WD to 4WD shortly prior to or upon reaching the first position.

In another example, in instances in which the powertrain control module 205 determines the soil may be soft at a second position based on environmental data obtained from the environmental sensors 215 that is associated with the second position (such that the soft soil may be likely to cause slipping in the wheels of the land drone 240), the powertrain control module 205 may direct the powertrain controller 230 to transition the powertrain 245 from 2WD to 4WD prior to reaching the second position. In some embodiments, the powertrain control module 205 may direct the powertrain controller 230 to transition the powertrain 245 between powertrains in instances when adverse operating conditions are present. Adverse operating conditions may include soft soil and other soft terrain, a grade of 5% or greater, precipitation and other potentially slippery surfaces, obstacles including tall vegetation, dense vegetation, and/or steps, and/or other conditions where the land drone 240 traction may be diminished.

In some embodiments, the powertrain control module 205 may direct the powertrain controller 230 to transition the powertrain 245 from 4WD to 2WD when adverse operating conditions are not present, which may reduce the amount of resources used by the powertrain control system 200. For example, in instances in which the powertrain control module 205 determines that the land drone 240 has moved from soft soil to a more compact driving surface (e.g., based on received input from one or more of the sensors 210), the powertrain control module 205 may direct the powertrain controller 230 to transition the powertrain 245 from 4WD to 2WD. In another example, in instances in which the powertrain control module 205 determines the land drone 240 has moved from a surface with a grade greater than 5% to a substantially horizontal surface, the powertrain control module 205 may direct the powertrain controller 230 to transition the powertrain 245 from 4WD to 2WD.

In some embodiments, the powertrain control module 205 may yield to operator input. For example, in instances in which the powertrain control module 205 determines that the powertrain 245 should be 2WD but the operator manually selects 4WD, the powertrain control module 205 may not attempt to change the powertrain 245 from 4WD. The powertrain control module 205 may not attempt to automatically adjust the powertrain 245 until the operator provides an input to reenable the powertrain control module 205 and/or after a period of time has elapsed. For example, after the operator has overridden the powertrain control module 205, the powertrain control module 205 may not attempt to adjust the powertrain 245 for one hour.

In some embodiments, the powertrain control module 205 may include software and/or hardware components capable of implementing artificial intelligence (AI) and/or machine learning. Alternatively or additionally, the powertrain control module 205 may transmit sensor data from the one or more sensors 210 to the land drone 240 and/or a remote system which land drone 240 and/or remote system may include the software and/or hardware components capable of implementing the AI and/or machine learning, which may be trained to determine which settings may work better than others based on certain conditions indicated by sensor input.

In some embodiments, the AI and/or machine learning may aggregate operator responses relative to the powertrain control system 200 and may relate the aggregated responses to detected operating environments and may make determinations about operations of the land drone 240 therefrom. For example, the AI and/or machine learning may associate the operator switching the powertrain 245 from 2WD to 4WD at a first location on multiple occasions and may direct the powertrain controller 230 to automatically switch the powertrain 245 from 2WD to 4WD in instances in which the land drone 240 nears the first location in the future.

In some embodiments, the AI and/or machine learning system may be integrated with the powertrain control module 205, such that the powertrain control module 205 may perform some or all of the functions of the AI and/or machine learning system. Alternatively or additionally, the AI and/or machine learning may be separate and/or distinct from the powertrain control module 205 and may be configured to communicate with the powertrain control module 205. For example, in instances in which the AI and/or machine learning is separate from the powertrain control module 205, the operation of the AI and/or machine learning of the powertrain system 205 may be performed by a computing system, such as the computing system 202 of FIG. 2.

In some embodiments, the powertrain control module 205 may be configured to load balance weight on the land drone 240. In some embodiments, the load balancing controller 235 may be configured to interface with the powertrain control module 205 and/or the land drone 240, such as one or more moveable weights on the land drone 240. The powertrain control module 205 may be configured to command the load balancing controller 235 to redistribute the one or more weights which may contribute to better control of the land drone 240 and less damage to the terrain in adverse operating conditions. For example, in instances where the rear wheels of the land drone 240 are slipping, the powertrain control module 205 may direct the load balancing controller 235 to redistribute weight on the land drone 240 toward the rear wheels. The load balancing controller 235 may be implemented in conjunction with or in addition to the powertrain controller 230 transitioning between powertrains. In some embodiments, the land drone 240 may include one or more weights disposed on or in the land drone 240 that may be controlled by the load balancing controller 235. For example, in instances in which the land drone 240 is an electric vehicle, the battery may be capable of moving forward, backward, to the left, to the right, and/or combinations thereof to contribute to load balancing as directed by the load balancing controller 235.

In some embodiments, the load balancing controller 235 may be configured to adjust the one or more moveable weights on the land drone 240 to improve the stability of the land drone 240. In some embodiments, the load balancing controller 235 may obtain operational data from the operational sensors 220 to determine instances in which load balancing for land drone 240 stability may be implemented. For example, in instances in which the operational sensors 220 determine the land drone 240 is approaching a tipping point (e.g., driving on a steep incline), the load balancing controller 235 may direct one or more weights on the land drone 240 to move which may adjust the center of mass of the land drone 240 such that the land drone 240 is more stable and/or less likely to tip over. In some embodiments, the load balancing controller 235 may be configured to proactively readjust the one or more weights on the land drone 240 once a threshold stability metric has been exceeded.

In some embodiments, the one or more weights controlled by the load balancing controller 235 may include motors that may be capable of moving the weights. For example, the one or more weights may be caused by the load balancing controller 235 to be adjusted by an electronic system of the land drone 240. In some embodiments, the one or more weights may be configured to move to help improve traction of the land drone 240 as needed. For example, in instances in which a land drone 240 is driving across the slope of a grade, the powertrain control module 205 may direct the load balancing controller 235 to cause the one or more weights to be adjusted to the uphill side of the land drone 240, which may improve traction. In another example, in instances in which a land drone 240 is driving through soft soil and where the rear wheels are slipping, the powertrain control module 205 may direct the load balancing controller 235 to cause the one or more weights to be adjusted toward the rear of the land drone 240, which may improve traction and may reduce damage to the soil.

In some embodiments, the load balancing system of the land drone 240 may include adjustable spring mechanisms, which may contribute to better control of the land drone 240 and may cause less damage to the terrain in adverse operating conditions. For example, in instances in which a land drone 240 is driving across the slope of a grade, the powertrain control module 205 may direct the load balancing controller 235 to cause the adjustable spring mechanisms on the uphill side of the land drone 240 to be loosened and the adjustable spring mechanisms on the downhill side of the land drone 240 to be stiffened which may contribute to greater stability of the land drone 240 and less damage to the terrain. The load balancing system of the land drone 240 may include the adjustable spring mechanisms in conjunction with or in addition to the powertrain control module 205 directing the transitions between powertrains and/or the powertrain control module 205 directing the redistribution of the one or more weights as part of the load balancing system.

In some embodiments, the powertrain control module 205 may direct the load balancing controller 235 to cause the adjustable spring mechanisms to be adjusted by an electronic system of the land drone 240. For example, the powertrain control module 205 may direct the load balancing controller 235 to cause the adjustable spring mechanisms to be stiffened or loosened as needed to improve traction and/or stability of the land drone 240 which may help reduce damage to the soil. In some embodiments, the amount of adjustment directed by the powertrain control module 205 to the adjustable spring mechanisms may be determined based on data from the one or more sensors 210, such as the operational sensors 220. For example, in instances where the operational sensors 220 detect the land drone 240 is on a steep incline, the powertrain control module 205 may direct the load balancing controller 235 to cause the adjustable spring mechanisms to be stiffened and/or loosened more than instances where the land drone 240 is on a gradual incline.

In some embodiments, the powertrain control module 205 may be attached to an existing agricultural vehicle, such as a tractor. Alternative or additionally, the powertrain control module 205 may be incorporated with a future agricultural vehicle, such as an autonomous land drone.

FIG. 3 illustrates a block diagram of an example computing system 302, according to at least one embodiment of the present disclosure. One or more of the computing system 302 may be included in a multi-operational land drone (e.g., the land drone 100 of FIG. 1 and/or the land drone 102 of FIG. 1) and may be configured to implement or direct one or more operations associated therewith. Additionally or alternatively, the computing system 302 may be included in and/or configured to implement or direct one or more operations associated with battery controllers and/or a removeable dashboard (e.g., the battery controllers 122 and/or the removeable dashboard 140 of FIG. 1). The computing system 302 may include a processor 350, a memory 352, and a data storage 354. The processor 350, the memory 352, and the data storage 354 may be communicatively coupled.

In general, the processor 350 may include any suitable special-purpose or general-purpose computer, computing entity, or processing device including various computer hardware or software modules and may be configured to execute instructions stored on any applicable computer-readable storage media. For example, the processor 350 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, the processor 350 may include any number of processors configured to, individually or collectively, perform or direct performance of any number of operations described in the present disclosure. Additionally, one or more of the processors may be present on one or more different electronic devices, such as different servers.

In some embodiments, the processor 350 may be configured to interpret and/or execute program instructions and/or process data stored in the memory 352, the data storage 354, or the memory 352 and the data storage 354. In some embodiments, the processor 350 may fetch program instructions from the data storage 354 and load the program instructions in the memory 352. After the program instructions are loaded into memory 352, the processor 350 may execute the program instructions. In some embodiments, one or more of the modules described in the present disclosure may be stored as program instructions.

The memory 352 and the data storage 354 may include computer-readable storage media for carrying or having computer-executable instructions or data structures stored thereon. Such computer-readable storage media may include any available media that may be accessed by a general-purpose or special-purpose computer, such as the processor 350. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 350 to perform a certain operation or group of operations.

Modifications, additions, or omissions may be made to the computing system 302 without departing from the scope of the present disclosure. For example, in some embodiments, the computing system 302 may include any number of other components that may not be explicitly illustrated or described.

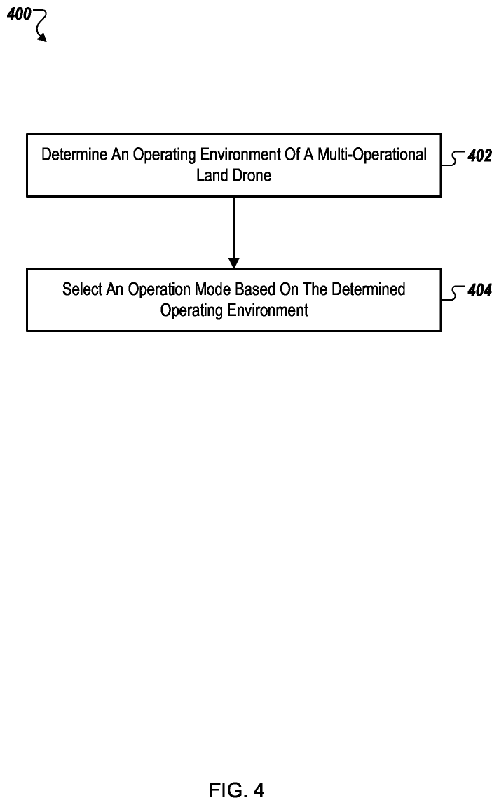

FIG. 4 illustrates an example flowchart of an example method 400 of selecting an operating mode of a multi-operational land drone, described according to at least one embodiment of the present disclosure. The method 400 may be performed by any suitable system, apparatus, or device. For example, one or more of the operations of the method 400 may be performed by a land drone and/or a computing system included in the land drone.

At block 402, an operating environment of a multi-operational land drone may be determined. For example, in some embodiments, sensor data such as that described above with respect to the sensors 130 of FIG. 1 and/or the sensors 210 of FIG. 2 may be obtained. Further, conditions about the environment such as those described above with respect to FIGS. 1 and 2 may be determined based on the sensor data and may be examples of the different operating environments that may be encountered by the land drone.

At block 404, an operating mode may be selected based on the determined operating environment. In some embodiments, the operating mode may be selected from a group of operating modes that includes a manual operating mode, a remote operating mode, and an autonomous operating mode. The manual mode may be such that the operator is physically present on the land drone and manually controlling the land drone while on the land drone, the remote operating mode may be such that the operator is not physically located on the land drone and is controlling the land drone via a control panel (e.g., the removeable dashboard of FIG. 1, and the autonomous operating mode may include the land drone autonomously performing one or more operations, with or without the operator being present. Further, the remote operating mode may include a line-of-sight mode or a teleoperation control mode.

Examples of selecting a certain operating mode include instances described above with respect to a hazard level of the operating environment (e.g., steepness of an incline, muddy conditions, icy conditions, etc.), proximity of the land drone to an operator in the operating environment, etc.

Modifications, additions, or omissions may be made to the method 400 without departing from the scope of the present disclosure. For example, the order of one or more of the operations described may vary than the order in which they were described or are illustrated. Further, each operation may include more or fewer operations than those described. For example, any number of the operations and concepts described above with respect to FIG. 1 or 2 may be included in or incorporated by the method 400. In addition, the delineation of the operations and elements is meant for explanatory purposes and is not meant to be limiting with respect to actual implementations.

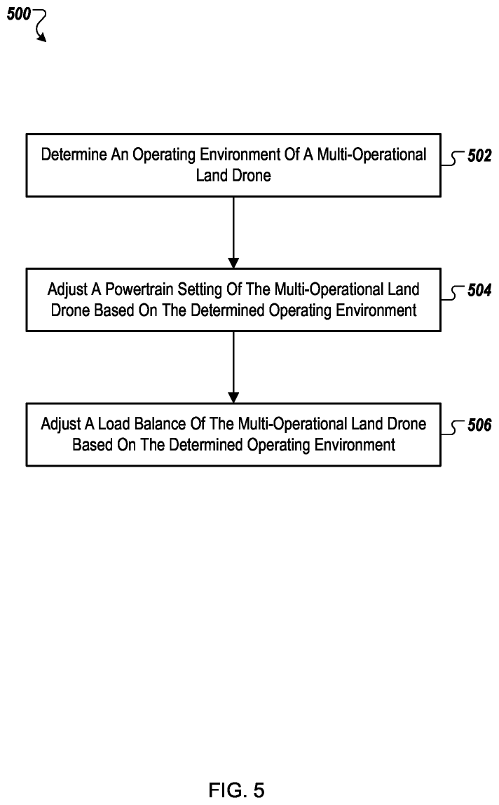

FIG. 5 illustrates an example flowchart of an example method 500 of adjusting a powertrain of a vehicle (e.g., a multi-operational land drone, tractor, etc.), described according to at least one embodiment of the present disclosure. The method 500 may be performed by any suitable system, apparatus, or device. For example, one or more of the operations of the method 500 may be performed by a power train control module and/or a computing system.

At block 502, an operating environment of the vehicle may be determined such as described above with respect to block 402 of FIG. 4.

At block 504, a power train setting of the vehicle may be adjusted based on the determined operating environment. In some embodiments, the power train setting may include any of the modes or operations described above with respect to FIG. 2. Further, the determination as to which setting to adjust and/or the adjustment type may be as described above with FIG. 2.

In these or other embodiments, at block 506, a load balance of the vehicle may be adjusted based on the determined operating environment. In some embodiments, the load balance adjustment may include any one or more of the operations described above with respect to FIG. 2 in relation to load balancing.

Modifications, additions, or omissions may be made to the method 500 without departing from the scope of the present disclosure. For example, the order of one or more of the operations described may vary than the order in which they were described or are illustrated. Further, each operation may include more or fewer operations than those described. For example, any number of the operations and concepts described above with respect to FIG. 1 or 2 may be included in or incorporated by the method 500. In addition, the delineation of the operations and elements is meant for explanatory purposes and is not meant to be limiting with respect to actual implementations.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” This interpretation of the phrase “A or B” is still applicable even though the term “A and/or B” may be used at times to include the possibilities of “A” or “B” or “A and B.” All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure. Accordingly, the scope of the invention is intended to be defined only by the claims which follow.

What is claimed is:

1. A multi-operational land drone, comprising:
a vehicle body;
one or more batteries disposed on a lower portion of the vehicle body;
one or more sensors disposed on the vehicle body; and
a removeable dashboard configured to control the vehicle body and the sensors.

2. A method comprising:
determining an operating environment of a multi-operational land drone; and
selecting an operation mode from a group of operation modes based on the determined operating environment, the group of operation modes including: a manual operating mode, a remote operating mode, and an autonomous operating mode.

3. A method comprising:
determining an operating environment of a multi-operational land drone;
adjusting a powertrain setting of the multi-operational land drone based on the determined operating environment; and
adjusting a load balance of the multi-operational land drone based on the determined operating environment.
